(19) United States
(12) Patent Application Publication
(10) Pub. No.: US 2022/0146950 A1
(43) Pub. Date: May 12, 2022

(54) MARKING PHOTOCONDUCTORS OF PRINT APPARATUSES

(71) Applicant: Hewlett-Packard Development Company, L.P., Spring, TX (US)

(72) Inventors: Eric G. NELSON, Boise, ID (US); Barry J. OLDFIELD, Boise, ID (US)

(73) Assignee: Hewlett-Packard Development Company, L.P., Spring, TX (US)

(21) Appl. No.: 17/435,517

(22) PCT Filed: Oct. 18, 2019
(86) PCT No.: PCT/US2019/056919

§ 371 Date: Sep. 1, 2021

(51) Int. Cl. G03G 5/047; G03G 15/00; G03G 15/10

(52) U.S. Cl. CPC G03G 5/047; G03G 15/104; G03G 15/752

(57) ABSTRACT

A photoconductor marking apparatus is disclosed. The apparatus includes a radiation source to emit radiation capable of irreversibly modifying photoconductive properties of a layer of a multi-layered photoconductor. The apparatus also includes processing apparatus to: determine a pattern to be applied to a photoconductor to be used in a print apparatus, the photoconductor having an imaging area within which print agent is to be deposited; and control the radiation source to direct radiation towards the photoconductor in a region outside the imaging area, so as to irreversibly modify photoconductive properties of a layer of the photoconductor according to the determined pattern. A method and a machine-readable medium are also disclosed.

### BACKGROUND

In liquid electrophotography (LEP) printing systems, a surface of a photoconductor is charged, then selectively discharged to form a latent image. The charged or uncharged portions of the photoconductive surface then receive print agent of the opposite charge, for subsequent transfer onto a transfer medium and onto a printable substrate. The photoconductor may be replaceable. However, it may be difficult to track photoconductors and to determine which particular photoconductor is installed within a print apparatus at any given time.

### BRIEF DESCRIPTION OF DRAWINGS

Examples will now be described, by way of non-limiting example, with reference to the accompanying drawings, in which:

FIG. 1 is a schematic illustration of an example of a liquid electrophotography print apparatus;

FIG. 2 is a schematic illustration of an example of a photoconductive surface marking apparatus;

FIG. 3 is a schematic illustration of a further example of a photoconductive surface marking apparatus;

FIG. 4 is a schematic illustration of an example of a photoconductor and a charge application unit;

FIG. 5 is an illustration of an example of a mark applied to a photoconductor;

FIG. 6 is a flowchart of an example of a photoconductive surface marking method;

FIG. 7 is a flowchart of a further example of a photoconductive surface marking method; and

FIG. 8 is a schematic illustration of an example of a processor in communication with a machine-readable medium.

### DETAILED DESCRIPTION

It is sometimes intended that particular print components are to be used in particular print apparatuses. For example, it may be intended that print components from a particular manufacturer may be used in a print apparatus from that same manufacturer to reduce the chance issues occurring due to incompatibilities between the print component and the print apparatus. This may be the case, for example, with print components that are intended to be replaced (sometimes referred to as consumables) when they become worn, and/or are nearing the end of their useful life.

An example of a print apparatus in which print components are used which may be removed and replaced periodically, is a liquid electrophotography (LEP) print apparatus. In a liquid electrophotography apparatus, print agent, such as ink, may pass through a print agent application assembly, such as a binary ink developer (BID). Each BID handles print agent of a particular colour, so an LEP printing system may include, for example, seven BIDs. Print agent from a BID is selectively transferred from a print agent transfer roller—also referred to as a developer roller—of the BID in a layer of substantially uniform thickness to a surface of a photoconductor, such as a photo imaging plate (PIP). The selective transfer of print agent is achieved through the use of an electrically-charged print agent, also referred to as a “liquid electrophotographic ink”. As used herein, a “liquid electrophotographic ink” or “LEP ink” generally refers to an ink composition, in liquid form, generally suitable for use in a liquid electrostatic printing process, such as an LEP printing process. The LEP ink may include chargeable particles of a resin and a pigment/colourant dispersed in a liquid carrier.

The LEP inks referred to herein may comprise a colourant and a thermoplastic resin dispersed in a carrier liquid. In some examples, the thermoplastic resin may comprise a copolymer of an alkylene monomer and a monomer selected from acrylic acid and methacrylic acid. In some examples, the thermoplastic resin may comprise a copolymer of an ethylene acrylic acid resin, an ethylene methacrylic acid resin or combinations thereof. In some examples, the thermoplastic resin may comprise an ethylene acrylic acid resin, an ethylene methacrylic acid resin or combinations thereof. In some examples, the carrier liquid is a hydrocarbon carrier liquid such as an isoparaffinic carrier liquid, for example Isopar-L™ (available form EXXON CORPORATION). In some examples, the electrostatic ink also comprises a charge director and/or a charge adjuvant. In some examples, the charge adjuvant includes aluminum di- or tristearate. In some examples, the liquid electrostatic inks described herein may be ElectroInk® and any other Liquid Electro Photographic (LEP) inks developed by Hewlett-Packard Company.

The photoconductor onto which print agent is selectively transferred is, in some examples, a replaceable component. In some examples, the photoconductor may comprise a sheet or flexible substrate (e.g. a belt) that is wrapped around a roller, a drum or a series of rollers. Over time, the photoconductor may become worn, leading to a reduction in the quality of printing that it is able to achieve. The photoconductor may then be removed and replaced with a new or different photoconductor.

It can be useful to track the precise photoconductor being used in a print apparatus, for example to analyse the length of time that each photoconductor is used before being replaced, or the number of images printed by a photoconductor before it is replaced.

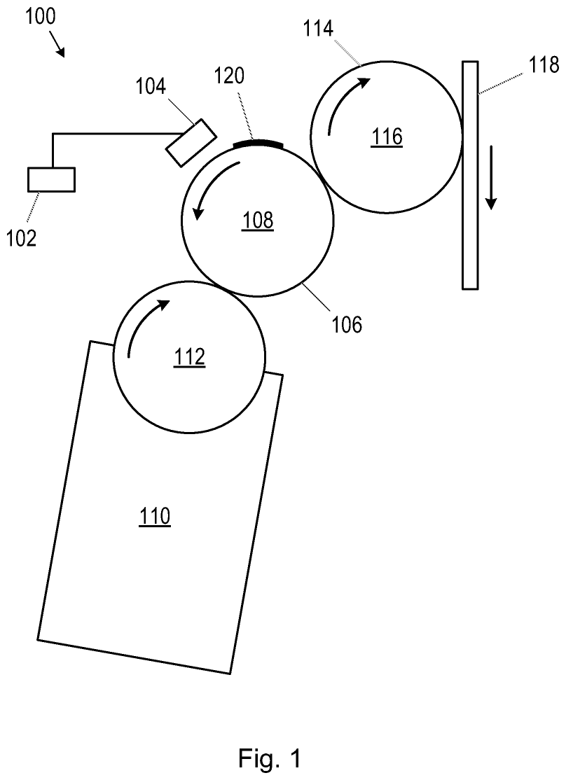

Referring now to the drawings, FIG. 1 is a schematic illustration of various components of a print apparatus. Aspects of the present disclosure may be applicable to a liquid electrophotography print apparatus, and various examples are described in relation to such print apparatuses. However, it will be understood that the present disclosure is also relevant to other types of print apparatuses in which a photoconductor is used. FIG. 1 shows the components of a print apparatus 100. Data representing an image to be printed is received by a processor 102, which controls a print head, or writing head 104, to form a latent image on a photoconductor 106. The photoconductor 106 may, in some examples, comprise the surface of a drum or roller 108, or the surface of a belt or flexible substrate wrapped around multiple rollers. In other examples, the photoconductor 106 may comprise the surface of a blanket which may, for example, be formed on or around the drum or roller 108.

The photoconductor 106 may be charged (i.e. with an electric charge) by a charge application unit (not shown) which, may, in some examples, comprise a charge roller. The writing head 104 comprises a plurality of light sources (not shown in FIG. 1) which, under control of processing circuitry (e.g. the processor 102), direct radiation onto the photoconductor 106 according to the image to be printed, to selectively discharge the charged photoconductor to create a latent image defining portions that are to receive print agent and portions that are not to receive print agent. The writing head 104 may also include an optical element or multiple optical elements to focus the radiation emitted from the light sources.

Once a latent image has been formed on the photoconductor 106, print agent (e.g. electrically charged LEP ink) is selectively transferred onto the charged regions of the photoconductor. In the example shown, print agent is provided from a print agent application assembly 110, also referred to as a binary ink developer, or BID. The print agent application assembly 110 includes various components in addition to those shown, which transfer print agent onto a developer roller 112. In the example shown, the developer roller 112 rotates in a direction opposite to the direction of rotation of the roller 108, as shown by the arrows in FIG. 1. Print agent is transferred from the developer roller 112 onto the discharged portions of the photoconductive surface 106 and, subsequently, onto a transfer medium 114, sometimes referred to as an intermediate transfer medium, or ITM. The transfer medium 114 may comprise a surface of a drum or roller 116 which may, in some examples, be referred to as a blanket drum. In other examples, the transfer medium 114 may be formed around the drum or roller 116. The roller 116 rotates in a direction opposite to the direction of rotation of the roller 108 and, as it rotates, print agent in the intended image to be printed is transferred from the transfer medium 114 onto a printable substrate 118 moving relative to the transfer medium.

According to examples of the present disclosure, the photoconductor 106 may be marked (e.g. with a mark 120) in such a way that it is possible to identify the photoconductor, and distinguish one photoconductor from another photoconductor. The present disclosure provides a method which may be used for marking a photoconductor, an apparatus for marking a photoconductor 106, and a machine-readable medium. An identifying mark 120 on a marked photoconductor 106 may be detected or “read” by a detector (not shown), which may for example be housed within the print apparatus 100, such that mark can be detected while the photoconductor is installed in the print apparatus.

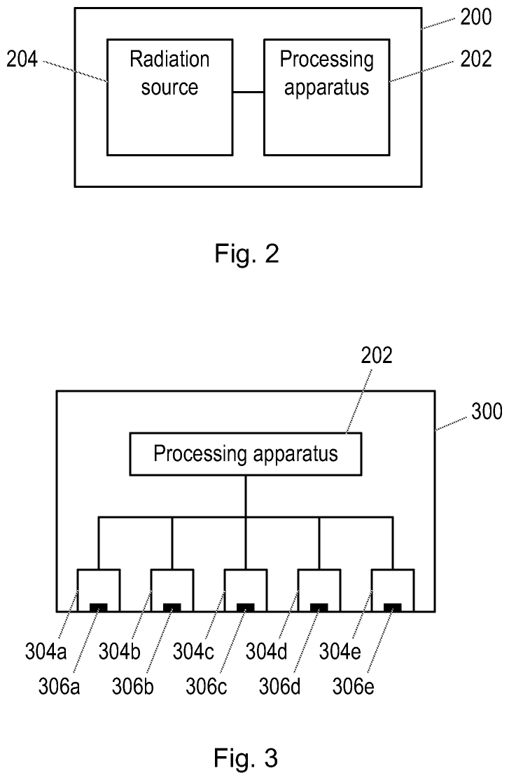

FIG. 2 is a schematic illustration of an example of a photoconductor marking apparatus 200. The photoconductor marking apparatus 200 comprises processing apparatus 202 and a radiation source 204. The radiation source 204 is to emit radiation capable of irreversibly modifying photoconductive properties of a layer of a multi-layered photoconductor 106. The photoconductor 106 may, for example, comprise a plurality of layers including a charge generation layer and a charge transport layer. During a printing operation, selectively charging the photoconductor 106 may comprise selectively charging a surface of the photoconductor. The charge generation layer and the charge transport layer are used to selectively neutralize the surface charge when the surface is exposed to light.

The charge level of the photoconductor 106 may be modified during a printing operation by the application of charge from the charge application unit, and/or by the application of radiation from the writing head 104. During such charging and discharging, the modifications to the photoconductor 106 may be considered reversible, such that the charged portions of the photoconductor may, over time, become discharged. The rate of discharge may be affected by the amount of light applied to the photoconductor 106. The radiation source 204, however, which is different to the writing head 104, is intended to emit radiation that is capable of modifying the photoconductive properties of a layer (or multiple layers) of the multi-layered photoconductor 106 in a permanent or irreversible manner, such that the charged portions do not discharge, or at least do not discharge during the intended useful lifetime of the photoconductor. Specifically, the radiation emitted by the radiation source 204 may change, or degrade, the light sensitivity of a region of the photoconductor, thereby reducing the rate of discharge of the photoconductor when light is applied, as compared to an unmodified region of the photoconductor. Modified regions of the photoconductor (i.e. those regions to which radiation from the radiation source 204 has been applied) may still discharge slowly. However, during a normal print cycle, the amount of discharge from the modified regions is minimal.

In some examples, the radiation source 204 may comprise an ultraviolet (UV) radiation source. Radiation within the UV waveband has an appropriate energy for irreversibly modifying photoconductive properties of layers of the photoconductor 106. Within the UV waveband, radiation having a relatively lower wavelength may be used, as this has a relatively higher energy, meaning that modification of the photoconductive properties of the photoconductor 106 may be achieved over a relatively shorter duration. Conversely, to achieve an equivalent degree of modification of photoconductive properties of layers of the photoconductor 106 using a relatively longer wavelength (having a relatively lower energy), the radiation may be directed at the photoconductor for a relatively longer duration. In some examples, the radiation source 204 may emit radiation having a wavelength of 365 nanometres (nm) or around 365 nm.

The processing apparatus 202 of the apparatus 200 may be operatively coupled to the radiation source 204, so that it can control and/or operate the radiation source 204 to cause radiation to be emitted. The processing apparatus 202 is to determine a pattern to be applied to a photoconductor 106 to be used in a print apparatus, the photoconductor having an imaging area within which print agent is to be deposited. The pattern may, for example, comprise an image, a mark, an alphanumeric character such as text of a number, a string of characters, or some other feature capable of being used to as an identifier, so that, once marked with the pattern, the photoconductor 106 may be distinguished from other photoconductors. The pattern may, therefore be regarded as an identifier. The mark formed on the photoconductor (i.e. in the pattern) is not an optically-readable mark. The mark may be detected and interpreted using detection techniques that are not discussed further herein. Such detection techniques may be performed within a print apparatus.

The pattern may be determined by the processing apparatus 202 retrieving an indication of a suitable or appropriate pattern from a database, or a lookup table, or may generate a pattern to be applied based on a rule, a set of rules, or a formula or algorithm. In some examples, the pattern may comprise a unique pattern. The pattern may, in some examples, be determined based on a numerical sequence; for example, patterns may be generated that correspond to numbers, with each number in a sequence differing by one digit from the previous number in the sequence. The pattern may, in some examples, be provided manually by a user, for example via a user interface (not shown). Thus, the processing apparatus 202 may determine the pattern to be applied based on the user input.

As is explained in greater detail below, the imaging area of the photoconductor 106 comprises a region within which charge may be applied by the charge application unit, and within which the latent image may be formed by selectively discharging portions of the imaging area of the photoconductor.

The processing apparatus 202 is also to control the radiation source 204 to direct radiation towards the photoconductor 106 in a region outside the imaging area, so as to irreversibly modify photoconductive properties of a layer of the photoconductor according to the determined pattern. Thus, the radiation is incident on a region of the photoconductor 106 which is not to be used for imaging (i.e. receiving print agent). In this way, the modification of the photoconductive properties of the photoconductor 106 in that region should have no effect on the photoconductive properties in the imaging area of the photoconductor and, as such, the application of the radiation from the radiation source 204 should have no adverse effect on the quality (e.g. image quality) of any printing performed using the photoconductor. As noted above, the modification of the photoconductor 106 by the radiation from the radiation source 204 is such that the photoconductor is able to be charged, but the modification of the photoconductor in the modified regions restricts or prevents its discharge in those regions. In the region of the photoconductor 106 which is not to be used for imaging, the photoconductor remains fully charged during the printing process so that ink doesn't transfer to the photoconductor in that region.

By irreversibly modifying photoconductive properties of a layer (or multiple layers) of the photoconductor 106 according to the determined pattern, the photoconductor becomes “marked” with a mark in accordance with the determined pattern. For example, if the determined pattern comprises a number (e.g. a serial number), then the radiation source 204 may be controlled to direct radiation onto the photoconductor in such a way that the resulting pattern resembles the serial number. In some examples, the area available outside the imaging area of the photoconductor 106 may be relatively small compared to the imaging area itself, so there may not be sufficient space available to mark an entire serial number, or any alphanumeric characters. In such examples, the determined pattern may comprise a relatively smaller pattern, such as a series of dots, dashes, lines or other marks, which are able to fit within the available region outside the imaging area.

As noted previously, the radiation source 204 may, in some examples, be such that the radiation it emits is capable of irreversibly modifying photoconductive properties of a single layer or multiple layers of the photoconductor 106. In some examples, the processing apparatus 202 may control the radiation source 204 to direct radiation towards the photoconductor 106 so as to irreversibly modify photoconductive properties of at least one of a charge generation layer and a charge transport layer of the photoconductor. For example, the processing apparatus 202 may control parameters of the radiation source 204 and/or parameters of a component associated with the radiation source (e.g. an optical component) to adjust the effect that the emitted radiation has on various layers of the photoconductor 106. In some examples, the processing apparatus 202 may control a wavelength of the radiation, an energy of the radiation, a distance between the radiation source 204 and the photoconductor 106 and/or an aperture size of an aperture through which radiation is to pass to reach the photodetector. By varying such parameters, the degree to which the photoconductive properties of a layer of the photoconductor 106 are irreversible modified can be controlled. Thus, the processing apparatus 202 may control the radiation source 204 to direct radiation towards the photoconductor 106 so as to irreversibly modify photoconductive properties of a layer of the photoconductor by one of a plurality of degrees of modification. Various degrees of modification may include, for example, directing the radiation towards the photoconductor 106 for a first duration to achieve a first degree of modification, for a second duration to achieve a second degree of modification, and for a third duration to achieve a third degree of modification. More or fewer degrees or levels of modification may be performed by adjusting various parameters of the radiation source 204 as discussed above.

Different levels of modification of the photoconductor 106 may be achieved caused by partially modifying photoconductive properties of a layer of the photoconductor, such that the discharge time of the photoconductor is reduced by different amounts. Partially modified regions of the photoconductor can be detected, and the different levels or degrees of modification can be used to create differences in the resulting marks. As discussed below, a single level of modification can be used to create a binary (i.e. mark or no mark) identifier. However, using differences in the level of modification, it is possible to encode an identifier using a high-order numbering system (e.g. 3-level encoding).

In some examples, radiation may be directed towards and onto the photoconductor 106 in a single, continuous pattern, such as an image. In other examples, however, radiation may be directed towards the photoconductor 106 in a plurality of discrete regions or areas, such that the resulting pattern comprises a pattern of multiple regions where the photoconductive properties of the photoconductor 106 have been irreversibly modified. Thus, in some examples, the processing apparatus 202 may control the radiation source 204 to direct radiation towards the photoconductor 106 so as to irreversibly modify photoconductive properties of a layer of the photoconductor in a plurality of discrete regions. In some examples, the photoconductor 106 in one or multiple of the discrete regions may be modified by a different degree of modification than other regions in the plurality of discrete regions.

As noted above, the pattern to be formed on the photoconductor 106 may be used to identify the photoconductor, so that the photoconductor can be tracked, for example, and/or so that it can be determined which photoconductor is installed in a particular print apparatus. Thus, in some examples, the processing apparatus 202 may control the radiation source 204 to direct radiation towards the photoconductor 106 so as to irreversibly modify photoconductive properties of a layer of the photoconductor in a pattern that is to be used to identify the photoconductor.

Reference is now made to FIG. 3, which is a schematic illustration of a further example of a photoconductor marking apparatus 300. The photoconductor marking apparatus 300 includes the processing apparatus 202. In this example, however, rather than a single radiation source 204 being used to emit radiation, multiple radiation sources are used. Thus, the photoconductor marking apparatus 300 may comprise a plurality of radiation sources 304 to emit radiation capable of irreversibly modifying photoconductive properties of a layer of a multi-layered photoconductor. In FIG. 3, the photoconductor marking apparatus 300 includes five radiation sources 304a, 304b, 304c, 304d and 304e. However, in other examples, more or fewer radiation sources may be provided. Each radiation source 304 may, for example, comprise a light-emitting diode (LED). In some examples, all of the plurality of radiation sources 304 may emit radiation at the same wavelength while, in other examples, the radiation sources may emit radiation at different wavelengths, such that each radiation source modifies the photoconductive properties of the photoconductor in a different way, or to a different degree.

The photoconductor marking apparatus 300 may also comprise an aperture 306 associated with each of the plurality of radiation sources 304, each aperture to direct radiation onto the photoconductor in a region of a defined shape and size. In FIG. 3, each radiation source 304a-e is provided with a respective associated aperture 306a, 306b, 306c, 306d and 306e. The apertures 306 may be the same size and/or shape as each other in some examples while, in other examples, the shape and/or sizes of some apertures may be different than other apertures. The shape and size of the aperture 306 is intended to define the shape and size of the pattern in which the radiation is directed onto the photoconductor. In some examples, an aperture may have a square or rectangular shape. In one example, the aperture may comprise a square aperture having a size of approximately 5 millimetres (mm) by 5 mm. The pattern formed on the photoconductor 106 by radiation passing through such an aperture may be appropriate to fit within a region of the photoconductor outside the imaging area.

The distance between the aperture 306 and the photoconductor 106, or between the radiation source 204 and the photoconductor may be selected based on the intended degree of modification to be made to the photoconductor. Similarly, the duration that radiation is applied to the photoconductor 106 (e.g. the duration that the radiation source 304 emits radiation) may be controlled according to the intended degree of modification to be made. In one example, the radiation source 304 (e.g. a UV radiation source) may be positioned approximately 1.7 mm from a surface of the photoconductor, and radiation may be emitted for between 1.5 seconds and 2 second.

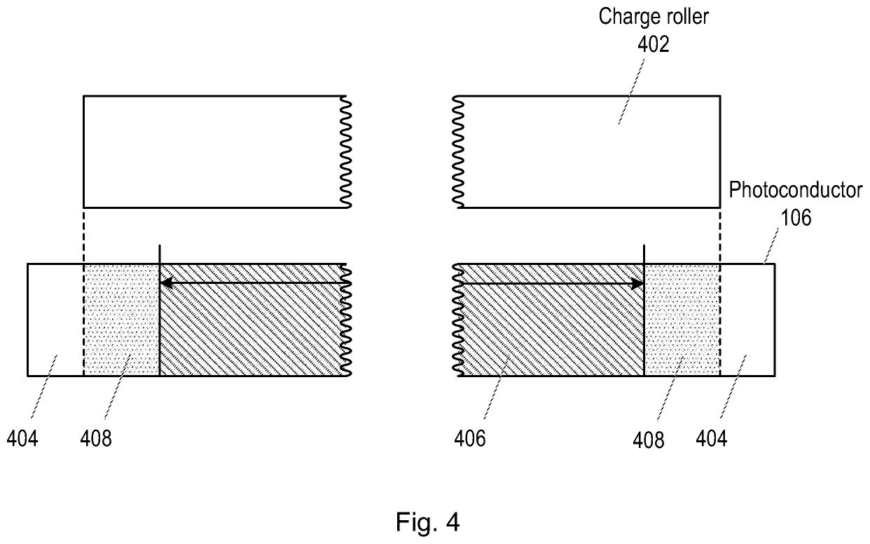

FIG. 4 is a schematic illustration of an example of a photoconductor 106 and a charge application unit 402. The charge application unit 402 may be used to apply a charge to the photoconductor 106 during a printing operation, prior to the latent image being formed on the photoconductor by selectively discharging portions thereof (e.g. using the writing head 104). The charge application unit 402 has a length that is shorter than the length of the photoconductor 106, such that the charge application unit 402 applies a charge to a portion of the photoconductor, and not to end regions 404 at the ends of the photoconductor. A hatched region 406 of the photoconductor 106 indicates an imaging area, within which the latent image may be formed and within which print agent may be deposited (e.g. on the charged portions of the photoconductor) during a printing operation. In FIG. 4, stippling is used to indicate a marking region 408 at each end of the photoconductor 106 between the imaging are 104 and the end regions 404. In some examples, radiation from the radiation sources 104 may be directed onto the photoconductor 106 within the marking region 408, for example at one or both ends. That is to say, the mark (e.g. the identifier) may be formed on the photoconductor 106 in the marking region 408.

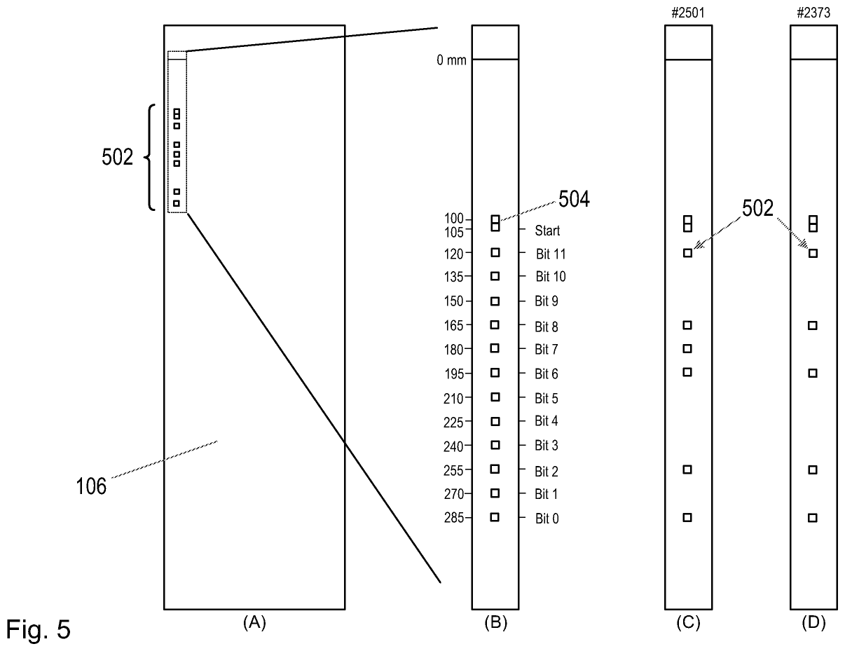

An example of a pattern in which a mark may be formed is described with reference to FIG. 5. FIG. 5 is an illustration of an example of an identifying mark 502 applied to a photoconductor 106. As shown in FIG. 5A, the identifying mark 502 is shown positioned towards one side of the photoconductor 106, for example, within the marking region 408 (not shown in FIG. 5). The photoconductor 106 in this example is shown as a sheet, which may be wrapped or formed around a roller or drum when installed in a print apparatus, as discussed above with reference to FIG. 1. In this example, the identifying mark 502 comprises a series of elements, which may for example comprise spots or squares. Depending on their arrangement, the spots of squares may represent a binary indicator. For example, the presence of a spot (formed as a result of the radiation irreversibly modifying photoconductive properties of a layer of a multi-layered photoconductor 106) in a particular position may represent a bit indicating a binary 1, and the absence of a spot in a particular position may represent a bit indicating a binary 0.

FIG. 5B shows an example of possible positions in which spots may be formed as part of the identifying mark 502. In this example, the identifying mark 502 comprises twelve bits (Bit 0 to Bit 11), spaced apart from one another by a defined spacing, as indicated by distances measured from a ‘start’ position at 0 mm. The presence or absence of a spot at each position/bit can be selected according to a numerical identifier that the identifying mark 502 is intended to represent. In this example, a pair of adjacent spots 504 are included at 100 mm and 105 mm, to act as a signal for a reader, notifying the reader that an identifying mark follows.

Examples of two different identifying marks 502 are shown in FIGS. 5C and 5D. In the example shown in FIG. 5C, the identifying mark 502 includes spots formed at bits 11, 8, 7, 6, 2 and 0, which represents an identifying number 2501. In the example shown in FIG. 5D, the identifying mark 502 includes spots formed at bits 11, 8, 6, 2 and 0, which represents an identifying number 2373. The pattern forming the spots corresponding to the identifying numbers may be determined by the processing apparatus 202, as discussed above. Each identifying number may be stored in association with the corresponding photoconductor 106 (e.g. in a database in a storage medium) so that each photoconductor can be identified by reading the identifying mark 502.

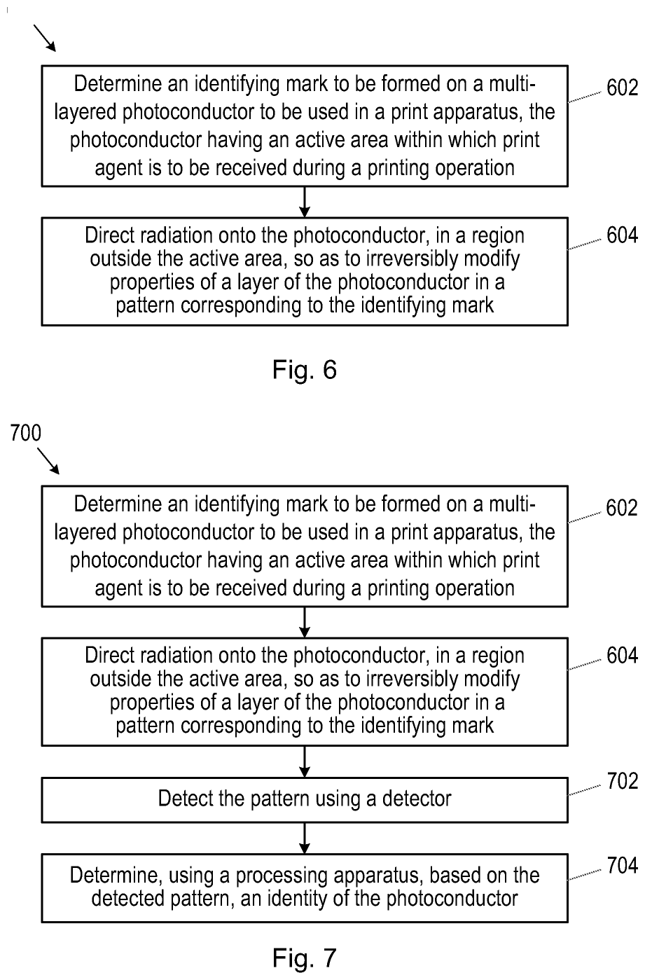

The present disclosure also provides a method. FIG. 6 is a flowchart of an example of such a method 600. The method 600 may comprise a method of marking a photodetector 106. The method 600 comprises, at block 602, determining an identifying mark to be formed on a multi-layered photoconductor 106 to be used in a print apparatus 100, the photoconductor having an active area within which print agent is to be received during a printing operation. The identifying mark to be formed may be determined (at block 602) by receiving an indication of the identifying mark via a user interface, from a user. In other examples, the identifying mark may be selected (e.g. by the processing apparatus 202) from a set of predefined marks stored in a memory. In other examples, as discussed above, the identifying mark may comprise a mark representative of a number in a sequence of numbers (e.g. a number following a number represented in the previous identifying mark formed on a photoconductor 106).

At block 604, the method 600 comprises directing radiation onto the photoconductor 106, in a region outside the active area, so as to irreversibly modify properties of a layer of the photoconductor in a pattern corresponding to the identifying mark. In some examples, the radiation may be directed onto the photoconductor 106 in the marking region 408, which is between the active area (e.g. the imaging area 406) and the end region 404 at each end of the photoconductor.

As noted above, and discussed with reference to FIG. 5, the pattern may, in some examples, comprise a binary identifier. For example, the pattern may comprise a pattern of dots, spots, or shapes arranged in a configuration indicating a representation of a number.

In some examples, directing radiation onto the photoconductor 106 may comprise directing radiation onto the photoconductor at one of a plurality of defined exposure levels. By varying the exposure time of the photoconductor to radiation from the radiation source 204, 304, it is possible to control the degree by which the photoconductive properties of the photoconductor are modified by the radiation. When detecting or reading the pattern formed on the photoconductor 106, a part of the identifying mark in the pattern that has been formed by a relatively long exposure to radiation may be interpreted differently to a part of the identifying mark in the pattern that has been formed by a relatively short exposure to radiation. The defined exposure levels may be considered to give rise to the different degrees of modification discussed above.

Irreversibly modifying properties of a layer of the photoconductor 106 may, in some examples, comprise causing charge generation and/or charge transportation properties of the layer to be irreversibly modified. In other examples, the photoconductive properties of one or both of the charge generation layer and the charge transportation layer may be irreversibly modified as a result of the radiation interacting with the photoconductor 106.

FIG. 7 is a flowchart of a further example of a method 700. The method 700 may also comprise a method of marking a photodetector 106, and may include blocks of the method 600 described above. The method 700 may, in some examples, further comprise, at block 702, detecting the pattern using a detector. The detector may comprise a sensor or detection unit capable of detecting the identifying mark on the surface of the photoconductor 106. Such a detector may form part of the print apparatus 100, such that the identifying mark can be detected and interpreted while the photoconductor 106 is installed within the print apparatus, for example during a printing operation, or between printing operations. The detector may be coupled to the processing apparatus 102, 202, such that data acquired by the detector (e.g. detection data) may be processed by the processing apparatus.

At block 704, the method 700 may comprise determining, using a processing apparatus (e.g. the processing apparatus 102, 202), based on the detected pattern, an identity of the photoconductor. In some examples, the processing apparatus 102, 202 may determine the identity of the photoconductor 106 by comparing the detected pattern with a set of patterns stored in a database, each in association with an identifier (e.g. a serial number) associated with a corresponding photoconductor. Blocks 602 and 604 may be performed prior to the photoconductor 106 being installed in a print apparatus, for example during, or soon after manufacture of the photoconductor. Blocks 702 and 704 may, in some examples, be performed in the print apparatus. For examples, components for performing blocks 702 and 704 may be included in or may form part of the print apparatus.

As discussed above with reference to FIG. 4, the photoconductor 106 may, in some examples, receive an electric charge in a chargeable region from a charge application unit 402. The charge application unit 402, which may comprise a charge roller, may provide charge to a region of the photoconductor 106 which includes the imaging area 406 and the marking areas 408 of FIG. 4. The radiation may, in some examples, be directed onto the photoconductor 106 in a region outside the active area (e.g. the imaging area 406), and within the chargeable region. Thus, with reference to FIG. 4, the radiation may be directed onto the photoconductor 106 in the marking region 408 at one or both ends of the photoconductor.

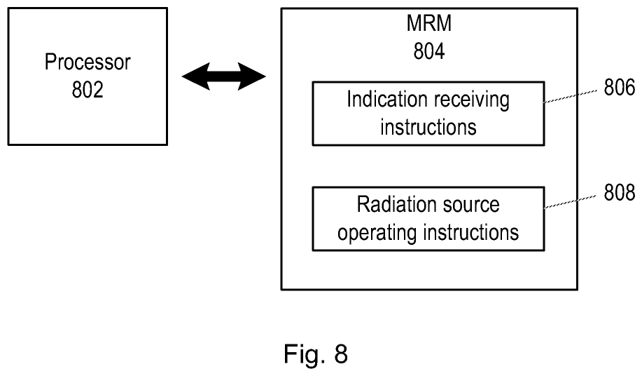

The present disclosure also provides a machine-readable medium. FIG. 8 is a schematic illustration of an example of a processor 802 in communication with a machine-readable medium 804. The processor 802 may comprise, or be similar to, the processing apparatus 202 discussed above. The machine-readable medium 804 comprises instructions (e.g. indication receiving instructions 806) which, when executed by a processor 802, cause the processor to receive an indication of a pattern to be applied to a multi-layered photoconductive structure 106 to be used in a print apparatus 100, the photoconductive structure having an imaging area 406 within which a latent image is to be created during a printing operation by selectively altering the charge of part of the photoconductive structure. The photoconductive structure 106 may comprise the photoconductor discussed herein.

The machine-readable medium 804 comprises instructions (e.g. radiation source operating instructions 808) which, when executed by the processor 802, cause the processor to operate a radiation source 204, 304 to emit radiation onto the photoconductive structure 106 in a region outside the imaging area 406, so as to irreversibly modify photoconductive properties of a layer of the photoconductive structure according to the pattern. In this way, an identifying mark may be formed on the photoconductive surface 106 in accordance with the pattern.

In some examples, the machine-readable medium 804 may comprise instructions which cause the processor 802 to operate the radiation source 204, 304 to emit radiation having sufficient energy for a sufficient duration to cause a portion of at least one of a charge generation layer and a charge transport layer of the photoconductive structure 106 to be irreversibly modified. It will be understood that if radiation is directed onto the photoconductive surface 106 for an insufficient duration and/or having an insufficient energy, then the charge generation layer and/or the charge transport layer of the photoconductive structure may not be irreversibly modified. Application of sufficient energy may be achieved by using radiation having a wavelength in the UV waveband, and a sufficient duration may be around 1.5 seconds to 2 seconds.

The present disclosure provides a mechanism by which a photoconductor of a print apparatus may be marked, by modifying photoconductive properties of the photoconductor using radiation. The resulting mark may be used for identifying the photoconductor. The mark may be formed on the photoconductor prior to installation in the print apparatus; for example, the radiation may be directed onto the photoconductor to form the mark during, or shortly after manufacture. The mark may be read or detected by a detector within the print apparatus, even after the photoconductor has been formed or wrapped around rollers, or around the drum or roller 108. In this way, the mark can be read, and thus the photoconductor can be identified, without the photoconductor being removed from the print apparatus, which may result in damage to the photoconductor.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A photoconductor marking apparatus comprising:
a radiation source to emit radiation capable of irreversibly modifying photoconductive properties of a layer of a multi-layered photoconductor; and
processing apparatus to:
determine a pattern to be applied to a photoconductor to be used in a print apparatus, the photoconductor having an imaging area within which print agent is to be deposited; and
control the radiation source to direct radiation towards the photoconductor in a region outside the imaging area, so as to irreversibly modify photoconductive properties of a layer of the photoconductor according to the determined pattern.

2. An apparatus according to claim 1, wherein the processing apparatus is to control the radiation source to direct radiation towards the photoconductor so as to irreversibly modify photoconductive properties of at least one of a charge generation layer and a charge transport layer of the photoconductor.

3. An apparatus according to claim 1, wherein the processing apparatus is to control the radiation source to direct radiation towards the photoconductor so as to irreversibly modify photoconductive properties of a layer of the photoconductor by one of a plurality of degrees of modification.

4. An apparatus according to claim 1, wherein the processing apparatus is to control the radiation source to direct radiation towards the photoconductor so as to irreversibly modify photoconductive properties of a layer of the photoconductor in a plurality of discrete regions.

5. An apparatus according to claim 1, wherein the processing apparatus is to control the radiation source to direct radiation towards the photoconductor so as to irreversibly modify photoconductive properties of a layer of the photoconductor in a pattern that is to be used to identify the photoconductor.

6. An apparatus according to claim 1, wherein radiation source comprises an ultraviolet, UV, radiation source.

7. An apparatus according to claim 1, further comprising;
a plurality of radiation sources to emit radiation capable of irreversibly modifying photoconductive properties of a layer of a multi-layered photoconductor;
an aperture associated with each of the plurality of radiation sources, each aperture to direct radiation onto the photoconductor in a region of a defined shape and size.

8. A method comprising:
determining an identifying mark to be formed on a multi-layered photoconductor to be used in a print apparatus, the photoconductor having an active area within which print agent is to be received during a printing operation; and
directing radiation onto the photoconductor, in a region outside the active area, so as to irreversibly modify properties of a layer of the photoconductor in a pattern corresponding to the identifying mark.

9. A method according to claim 8, wherein the pattern comprises a binary identifier.

10. A method according to claim 8, wherein directing radiation onto the photoconductor comprises directing radiation onto the photoconductor at one of a plurality of defined exposure levels.

11. A method according to claim 8, further comprising:
detecting the pattern using a detector; and
determining, using a processing apparatus, based on the detected pattern, an identity of the photoconductor.

12. A method according to claim 8, wherein irreversibly modifying properties of a layer of the photoconductor comprises causing charge generation and/or charge transportation properties of the layer to be irreversibly modified.

13. A method according to claim 8, wherein the photoconductor is to receive an electric charge in a chargeable region from a charge application unit, and wherein the radiation is directed onto the photoconductor in a region outside the active area, and within the chargeable region.

14. A machine-readable medium comprising instructions which, when executed by a processor, cause the processor to:
receive an indication of a pattern to be applied to a multi-layered photoconductive structure to be used in a print apparatus, the photoconductive structure having an imaging area within which a latent image is to be created during a printing operation by selectively altering the charge of part of the photoconductive structure; and
operate a radiation source to emit radiation onto the photoconductive structure in a region outside the imaging area, so as to irreversibly modify photoconductive properties of a layer of the photoconductive structure according to the pattern.

15. A machine-readable medium according to claim 14, further comprising instructions which cause the processor to operate the radiation source to emit radiation having sufficient energy for a sufficient duration to cause a portion of at least one of a charge generation layer and a charge transport layer of the photoconductive structure to be irreversibly modified.
